(19) United States
(12) Patent Application Publication
(10) Pub. No.: US 2022/0349215 A1
(43) Pub. Date: Nov. 3, 2022

(54) EMERGENCY DUTY EXIT SECURING STRIP

(71) Applicants: Steven Koszis, Glendale, CA (US); Christopher Brewer, Valencia, CA (US)

(72) Inventors: Steven Koszis, Glendale, CA (US); Christopher Brewer, Valencia, CA (US)

(21) Appl. No.: 17/244,954

(22) Filed: Apr. 30, 2021

(51) Int. Cl. E05B 63/18

(52) U.S. Cl. CPC E05B 63/18

(57) ABSTRACT

An Advanced Emergency Duty Exit Securing Strip having length and elasticity enough to hold open almost any exit device is made of a thin, tough elastomer. A first handle-adaptive hole provides multiple methods to secure a door knob, handle, pushbar, magnetic closure or lever on one side of the door. A constriction slot adjacent the handle-adaptive hole prevents inadvertent loosening of looping methods for securing a door. A latch-enveloping middle portion of the Strip has width and puncture strength enough to cover a door's latch-bolt and strike plate or other latching portion and restrain any spring-bolts or latches from engaging. The remaining handle-adaptive end portion of the Strip wraps around to the far side of the door and secures the far side door mechanisms using one of the multiple methods. Depending on door tolerances, the door will either wedge open or the exit device will be prevented from engaging.

### CROSS-REFERENCE TO RELATED APPLICATION

This application is a continuation-in-part of, and claims priority under 35 U.S.C. § 120 from, nonprovisional U.S. patent application Ser. No. 16/035,451, entitled “DISPOSABLE EMERGENCY DUTY LATCH DISABLING STRIP”, filed 13 Jul. 2018, the subject matter of which is incorporated herein by reference. Application Ser. No. 16/035,451, in turn, claims priority under 35 U.S.C. § 119(e) from U.S. Provisional Patent Application No. 62/539,461, entitled “DISPOSABLE EMERGENCY DUTY LATCH DISABLING STRIP”, filed 31 Jul. 2017.

### FIELD OF THE INVENTION

The invention disclosure relates a flexible, piece of emergency duty personnel kit deployable in a variety of configurations to reliably disable locks, latches, pushbars, magnetic locks and other closures on doors and gates in dangerous conditions.

### BACKGROUND

First responders, including law enforcement officers, parole officers, probation officers, firefighters, paramedics, EMTs and EMS workers frequently encounter an unknown locking or lockable gate or door. To secure their own exit, and to assure that other first responders can follow, they often have to search, in the dark and in a hurry, to find something to block the door open and prevent any locking mechanisms on the door from engaging. Actual common improvised door blocking mechanisms include jamming wadded up paper into the strike plate hole, stuffing a business card into the lock, strips of duct tape pre-disposed on a flashlight handle, or hoping to find a trash can, a rug, or a brick to simply prop the door open.

Improvised door-blocking mechanisms take away critical time needed to render aid on any emergency call. They are too often removed by passers-by, fail due to environmental conditions or simply fall out of place unnoticed when the next officer opens the door.

What is needed is a first responder's tool for quickly disabling all sorts of door and gate locking mechanisms and preventing doors and gates from closing behind them. Because first responders are already burdened with tools, it should be light, fit in almost any pocket and be deployable in seconds. It must be weatherproof and chemical resistant. It should provide multiple means for stretching, typing, looping, compressing or otherwise affixing to the large variety of door closures encountered. It should be tough, reliable and reusable but also, ideally, economical and disposable, since such a tool will often get left behind during emergencies.

### SUMMARY OF THE INVENTION

An Emergency Duty Exit Securing Strip having, in combination, length and elasticity enough to fit around almost any door jamb security mechanism is made of a thin, tough elastomer. A first rounded end portion with a handle-adaptive hole fits around a door knob, handle or lever on one side of the door. A latch-enveloping middle portion of the Emergency Duty Exit Securing Strip has, in combination, width and puncture strength enough to cover a door's latch-bolt and strike plate or other latching portion and restrain any spring-bolts or latches from engaging. The remaining handle-adaptive end portion of the Strip wraps around to the far side of the lockable door and is attached to the far side door mechanisms using the remaining handle-adaptive hole. Depending on door tolerances, the door will either wedge open or the lock will be prevented from engaging. The Emergency Duty Exit Securing Strip is thin, flexible and can be folded or rolled to deploy from a pocket, belt pouch, clasp or dispenser.

### BRIEF DESCRIPTION OF THE DRAWINGS

FIG. 1 (PRIOR ART) shows a bulky door-knob hanger device intended for propping a door partially open under non-emergency conditions.

FIG. 2 is an unfolded view of the Emergency Duty Exit Securing Strip showing the latch-enveloping middle portion between the two handle-adaptive end portions according to the preferred embodiment.

FIG. 3 is a perspective view of the Emergency Duty Exit Securing Strip showing the device flexed and folding under its own weight such that the side-on edge is apparent.

FIG. 4 is an illustration of the Emergency Duty Exit Securing Strip deployed so as to disable the latching of an old-fashioned overlapping pair of doors

FIG. 5 is an illustration of the Emergency Duty Exit Securing Strip deployed against a modern industrial-grade door with lever handles and an off-center spring-bolt.

FIG. 6 shows a configuration of the emergency duty exit securing strip that includes a constriction slot as part of one handle-adaptive end portion.

FIG. 7 illustrates a further configuration of the emergency duty exit securing strip that includes bolus points for guiding and holding a closed loop in place in conjunction with the constriction slot as disclosed above in regard to FIG. 6.

FIG. 8 illustrates a further configuration of the emergency duty exit securing strip that features two constriction slots for improved friction retention.

FIG. 9 illustrates a configuration of the emergency duty exit securing strip wherein a crashbar-adaptive through-hole is increased in sized lengthwise, so as to wrap around a cross-bar exit device or around a pad of a touch-bar exit device.

FIG. 10 illustrates a method of using the novel emergency duty exit securing strip developed to disable a magnetic plate door lock.

FIG. 11 illustrates a method of using the novel emergency duty exit securing strip developed to disable and hold unlocked an exit device known as a cross-bar (or lever-bar).

FIG. 12 illustrates a method of using the novel emergency duty exit securing strip developed to disable a latch where one side of the door uses a loop handle.

FIG. 13 illustrates a method of using the novel emergency duty exit securing strip developed to disable and hold unlocked an exit device known as a touch bar.

FIG. 14 In a variation of the compression method of FIG. 13, above, a compression knot may be formed over the middle portion of a touch bar exit device without a windlass rod.

FIG. 15 illustrates a method of using the novel emergency duty exit securing strip developed to disable a latch where the door uses a rectangular push handle exit device.

FIG. 16 illustrates a method of using the novel emergency duty exit securing strip developed to disable and hold unlocked a touch bar exit device.

### DETAILED DESCRIPTION

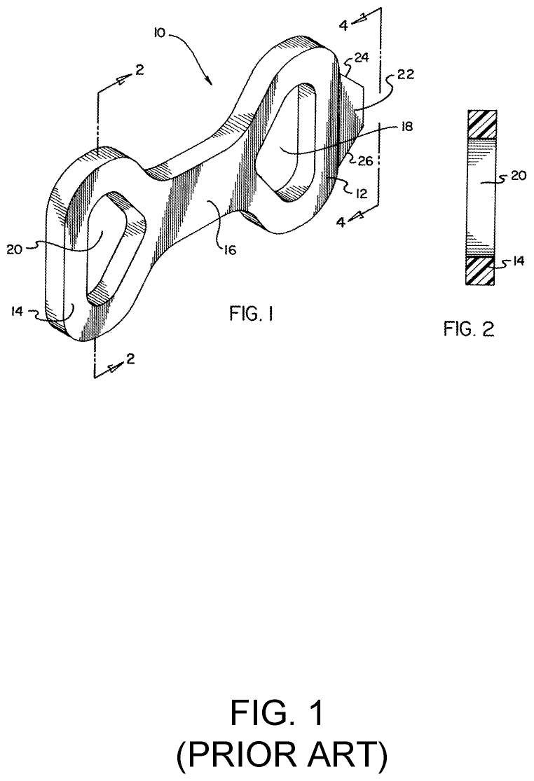

FIG. 1(PRIOR ART) shows a bulky door-knob hanger device intended for propping a door partially open under non-emergency conditions in the prior art at U.S. Pat. No. 5,291,631. A flexible, rubber-like member in the shape of a flat “dumbbell” has a pair of holes at either enlarged end thereof for fitment respectively about the opposed knobs or handles of a door with the narrow portion thereof wrapping around the side edge of the door proximal the knobs to prevent closure of the door.

The thick rubber of the device of FIG. 1 is rigid enough to hold a shape with triangular holes and such that the middle portion is narrower than the two end portions. The narrow middle portion is neither wide enough to reliable cover a strike-plate hole nor flexible enough to wrap around and cover a spring-bolt. Instead, the device of FIG. 1 simply wedges a door open with its thick bulk. The thickness of the material is required to allow the implanting of signaling mechanisms, and the large, rigid door knob holes are designed for the doors of a children's nursery. The device, overall, is too large and rigid to be or portable as part of emergency equipment or deployable in numbers. Nor is it adaptable to many door configurations.

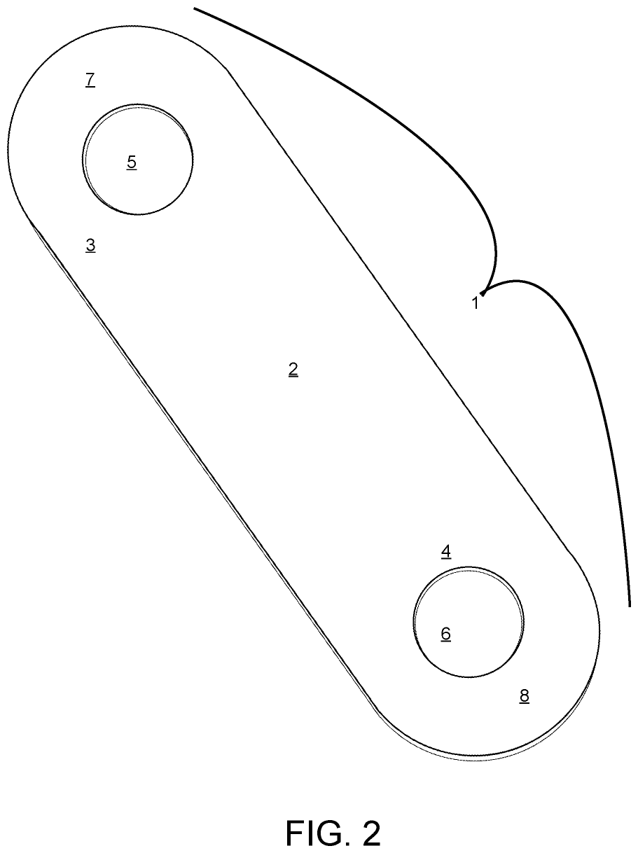

FIG. 2 is an unfolded view of the Emergency Duty Exit Securing Strip 1 showing the latch-enveloping middle portion 2 between the first 3 and second 4 handle-adaptive end portions according to the preferred embodiment. For ease and economy of manufacturing, the Emergency Duty Exit Securing Strip can be manufactured by die-cutting: a sheet or strip of elastic material is cut to produce the sought shape of a particular elongated strip with handle-adaptive holes 5 and 6 for accommodating door mechanisms at either end. Alternatively, the device of the invention can be manufactured by solidifying in a mold of the sought shape. In the preferred embodiment, the sought strip has a lozenge, or rounded rectangle, shape, with a radius or semi-circular surrounding portion at each end 7 and 8 surrounding each handle-adaptive hole. The lozenge shaped strip is not made with shape corners in the preferred embodiment, as corner material would contribute extra bulk without contributing material strength.

The elastic material used in the Emergency Duty Exit Securing Strip can be any elastomer capable of being manufactured to the specifications in this disclosure and used to prevent a door from locking according to the methods described in this disclosure.

Elastomers that are possible include solid neoprene, natural gum rubber, silicone and latex. The elastomer type is not critical to the product, so long as it falls within most or all of the specifications.

Gum rubber and solid neoprene, in particular, have been found to be manufacturable both to meet the specifications of this disclosure and for economy. Natural gum rubber can suffice for police applications, for example, since it withstands temperate ranges between 212 F to −20 F and can be manufactured inexpensively.

For firefighter applications, an elastic silicone strip can be preferable. Molding and curing of silicone can be more expensive than gum rubber, and silicone can have poorer elastic properties at moderate temperatures than gum rubber, necessitating more material. However, at extreme temperatures, silicone rubber is more durable than gum rubber. Typical silicone rubbers can function to arrest door latches in this application at temperatures as high as 572 degrees Fahrenheit and as low as −178 degrees Fahrenheit.

Some silicone rubber gasket materials can intermittently stand temperatures up to 650 Fahrenheit. Other silicone rubbers specially formulated for extreme temperatures, such as Resbond Fireproof, can survive up 2350 degrees Fahrenheit. This application contemplates use of such high temperature elastomers in cases where they also exhibit sufficient tensile strength to resist tearing and sufficient hardness at ⅛ inch thickness to arrest a fifteen-pound spring-bolt.

In terms of tensile strength, even the weaker silicones such as Room Temperature Vulcanize exhibit strength of 800 psi or more and can be made to have elasticity of up to 370%. Others, such as Fluorosilicone Rubber and High Consistency Rubber, can have much higher tensile strength and elasticity.

By matter of contrast, foam or closed-cell neoprene has not been found to be usable in the door-latch disabling application of the Strip because it lacks the tear strength or puncture resistance to reliably impede spring-bolts. Similarly, an elasticized cloth material such as Spandex would likely be usable only if it is a latch-adaptive elasticized cloth material made thick enough to arrest a latch-bolt and to wedge a doorjamb, and if it is not used for firefighter applications where the cloth matrix would catch fire.

And, a non-elastic material is not workable in this application due to the versatility of door locks, gate locks, window locks and security device configurations encountered by emergency personnel.

It is noted that the latch-enveloping middle portion is at least as wide as the two handle-adaptive end portions. In the preferred embodiment, the Emergency Duty Exit Securing Strip has a width of three inches. The three inch width allows the latch-enveloping middle portion to cover and restrain the latch-bolt of various configurations found in gates and doors in commercial, industrial and residential applications where a latch-bolt might be offset from the doorknobs or levers. A 20% width variance in either direction is functional but not preferred, so the latch-enveloping middle portion can be from 2.4 to 3.6 inches wide.

Note that an alternate embodiment can give the latch-enveloping middle portion greater latch-engaging width by cutting the Strip in an oval shape, with the latch-enveloping middle portion increasing to a middle width greater than the two handle-adaptive end portion widths.

In the preferred embodiment, the Strip has a ten inch length at rest—when not being stretched. This, along with the elasticity, allows it to wrap around most door edges, handles, locking mechanisms, keypads and any other installed security devices or features of the door. A 20% length variance in either direction is functional but not preferred, so the Strip can be from 8 to 12 inches in length.

Also in the preferred embodiment, the handle-adaptive end portions have handle-adaptive through-holes one and one quarter inch, or five-quarter inches, in diameter. This size handle-adaptive hole, combined with the elongation properties of the elastomer, allows for the handle-adaptive end portions to be stretched and slipped over most knobs, handles, levers and other mechanisms used to open doors. A 20% diameter variance in either direction is functional but not preferred, so the handle-adaptive holes may be between one and one-and-one-half inch. The handle-adaptive through-holes have an edge of elastomeric material which may also be called a perimeter.

In the case of through-holes that are not circular, at least one perimeter edge or diagonal should be between one and one & one-half inch. Further, the handle-adaptive holes allow for the Strip to be wrapped through itself when tied around a door handle without a knob or lever, and secured when otherwise adapted to unusual door configurations. Here, a standard door handle may be defined as any of a knob, handle, lever, door-pull, U-bar, push-bar, extruded lock, combination lock panel, or other commonly manufactured door opening, locking or pulling mechanism and capable of having a strip of elastic material tied, wrapped or adhered to it.

Due to manufacturing variances, and because the Strip is elastic, some variation in width of the latch-enveloping middle portion, length of the Strip, size of the handle-adaptive through-holes, and in other measurements is possible. However, because the Strip must resist breaking, abrading and tearing in cold, in heat, in emergency situations and with a wide range of door configurations, dimensions and tolerances of less than eighty percent those described in regard to the preferred embodiment can not be considered reliable.

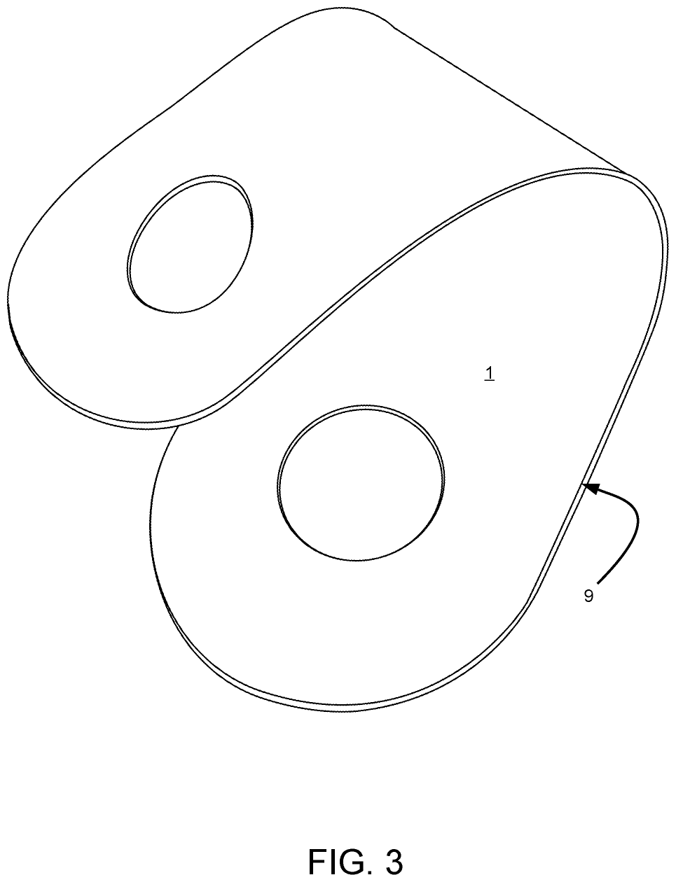

FIG. 3 is a perspective view of the Emergency Duty Exit Securing Strip 1 showing the preferred embodiment flexed and folding under its own weight such that the side-on edge 9 is apparent. The side-on edge thickness can be one-sixteenth inch to one-eighth inch ( 1/16″-⅛″), depending on material. This thickness is used because it can physically prevent a door from closing by wedging between the door and doorjamb. It is also thick enough to wedge some doors with close tolerances. However, the Strip is also thin enough to carry discreetly in pockets whether rolled or folded. And, in combination with the chosen elastomer material, testing shows that materials within this range of thicknesses ensures the latch-enveloping middle portion has the puncture-resistance and deformation-resistance to restrain spring-bolts and other latch-bolts.

The elastomer of the Strip in the preferred embodiment is capable of a minimum elongation (tip to tip) of three times or three-hundred percent (300%). This elongation property is important so that the Strip has a compact form in its relaxed state to carry discreetly in a compact storage compartment. A 20% elasticity variance is functional but not preferred, so the Strip elastomer material must have an elasticity of at least 240%. Thus, the stretch length in a Strip having a 10 inch rest length and 300% elasticity of the preferred embodiment will be 30 inches. The stretch length in an alternate embodiment Strip having an 8 inch rest length and 240% elasticity will be 19.2 inches. Different sizes and elongations may be manufactured for regions with different building practices.

It is also preferred that the elongation property be under 360%, in order to retain deformation resistance. Elongation also allows the Strip to relax short or stretch long, thus giving the range of differences in reach needed to wrap around numerous types of doors and gates with or without security features that increase the effective distance from one side of the door to the other. In contrast, a Strip of strong, flexible plastic without the ability to elongate would need to be approximately thirty inches in length to wrap around the effective distances from one side of a door to the other. Such a long Strip would need to be laboriously wrapped and knotted for shorter effective distances, and would be subject to tangling, making for a less desirable embodiment of the invention.

The material of the Strip at its given thickness must be capable of resisting tearing as it elongates. Thus, the Strip should have a tensile strength of seven hundred pounds per square inch (700 PSI) in the preferred embodiment. This strength is important so a user will not inadvertently tear the product by applying too much pressure using human force alone. A 20% variance in tensile strength is functional but not preferred, so a minimum tensile strength of 560 pounds per square inch (560 PSI). A stretch strength of at least 560 PSI allows the product to withstand most stresses and door configurations.

Finally, the partially bent shape of the Strip in FIG. 3 illustrates the hardness of the invention. The invention folds under its own weight, but does not so fold completely flat. Instead, the Emergency-Duty Latch-Disabling Strip naturally maintains is original shape and returns to a flat position. The Strip of the invention is hard enough to withstand punctures by latch-bolts or the pressure of doors slammed closed on it. However, the invention of the disclosure must also be soft enough to remain flexible for storage in compact pockets, but flexible enough to allow twisting without compromising integrity or tearing.

Testing has shown that the invention must, therefore, be made of elastic material with a durometer of at least 36, and at most 54, according to the Shore A hardness test. In the preferred embodiment, the Emergency Duty Exit Securing Strip has a durometer of 45, with an allowable variation of plus or minus 20% according to the Shore A hardness test (45 Shore A, +/−5). This degree of hardness allows the Strip to successfully restrain a 15-pound spring-bolt, which is the maximum spring-bolt force typically used in light of disability concerns.

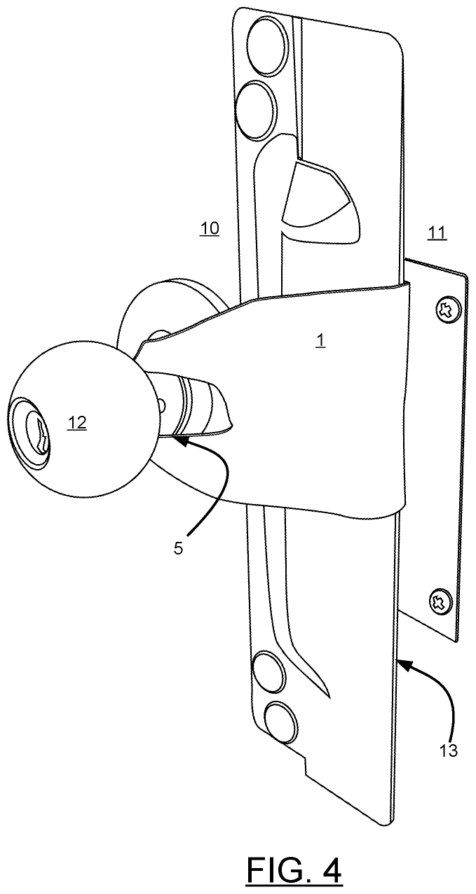

FIG. 4 is an illustration of the Emergency Duty Exit Securing Strip deployed so as to disable the latching of an old-fashioned overlapping pair of doors 10 and 11. The illustration accompanies a description of methods of using the invention. Here, arresting the latch is defined to be disabling the locking operation of a door as follows: The Strip material restrains the spring-bolt or dead-bolt partially or entirely inside the bolt-hole such that it does not engage its locking mechanism or such that it does not engage the door jamb or strike plate sufficiently to lock the door. Alternatively, arresting the latch is accomplished when the Strip material restrains the door edge from fitting into the door jamb, holding it open.

For the purpose of claiming the invention, an adjacent door edge may be defined as the long edge of a door opposite the hinged edge and containing the locking mechanism allowing a locking bolt to interface with a strike-plate when the door is shut and the adjacent door edge is flush with the door jamb. Such adjacent edge will therefore also typically be adjacent any standard door handle.

As noted above, the Strip is flexible and foldable. Thus, a first-responder or other user can add the Strip to his equipment by folding or rolling one or more Emergency Duty Exit Securing Strips into a compact shape and fitting them into a pocket or belt pouch. One or more Strips can also be hooked onto a belt, buckle, snap, clasp or hook through the handle-adaptive holes of the end portions, or even temporarily tied around a belt, belt loop or even an arm by pulling one end through the handle-adaptive hole of the opposite end. In some cases, multiple Strips will be packaged pre-folded in a box or dispenser that can be carried in a vehicle, backpack or large pocket.

When the user encounters a lockable door that he intends to prevent from becoming locked, so as to maintain entry during emergency situations, the Strip is quickly deployed with the primary goal of preventing spring-bolt or dead-bolt locks in the door from engaging. The user fits one of the handle-adaptive holes around one door knob, handle or lever, just as a handle-adaptive hole 5 is shown fitted around the round door-knob 12 of FIG. 4. The user then wraps the Strip 1 around the adjacent edge 13 of the door 10, making sure that the latch-enveloping middle portion 2 covers the latch-bolt.

If a spring-bolt is present, the latch-enveloping middle portion can undergo some deformation; the user checks that the latch-enveloping middle portion is effectively restraining the spring-bolt from locking the door. The user fits the remaining handle-adaptive hole around the knob, lever or other appropriate feature on the other side of the door, stretching the Strip if necessary.

If the Strip is, at this point, loose or hanging or the user simply wants to tighten the Strip to discourage removal, he can wrap, wind, twist or knot one handle-adaptive end portion around a door knob or lever before fitting the handle-adaptive hole over the knob. Alternatively, he can wrap one handle-adaptive end portion around the knob before tightening by pulling the other end portion back through its handle-adaptive hole.

In the same manner, door handles such as push-bars, door-pulls, U-bars, large keypads and others that cannot be dealt with by fitting a handle-adaptive through-hole over an extrusion can, instead, be handle by tying. The user loops a first end portion of the flat elastomer strip around such a door handle and then pulls the other end portion through the through-hole of the first end portion, making a closed loop around the handle.

Note that the overlapping type of double-door depicted in FIG. 4 can be held unlocked while appearing nearly closed using the thin Strip of the invention. In some cases, this will be a help to emergency personnel who wish to avoid drawing bypasser attention to the disabled door lock. The Emergency Duty Exit Securing Strip of the invention can be manufactured in low-noticeability colors Steel Gray, Desert Tan, Tactical Black, and transparent or translucent colors.

Other users may prefer the Emergency Duty Exit Securing Strip to have bright high-visibility coloring to alert other emergency responders, or even printed patterns or warnings to dissuade bypassers. Particular colors or markings of the Strip can even be matched to particular users or agencies to indicate to follow-on responders who the Strip was placed by.

One embodiment of the Strip specialized for use by firefighters incorporates a photoluminescent additive to the elastomer which makes the Strip produce a visible glow in hot, smoke-filled buildings. This aids a firefighter in visually locating the door through which he entered, and support personnel in following his path.

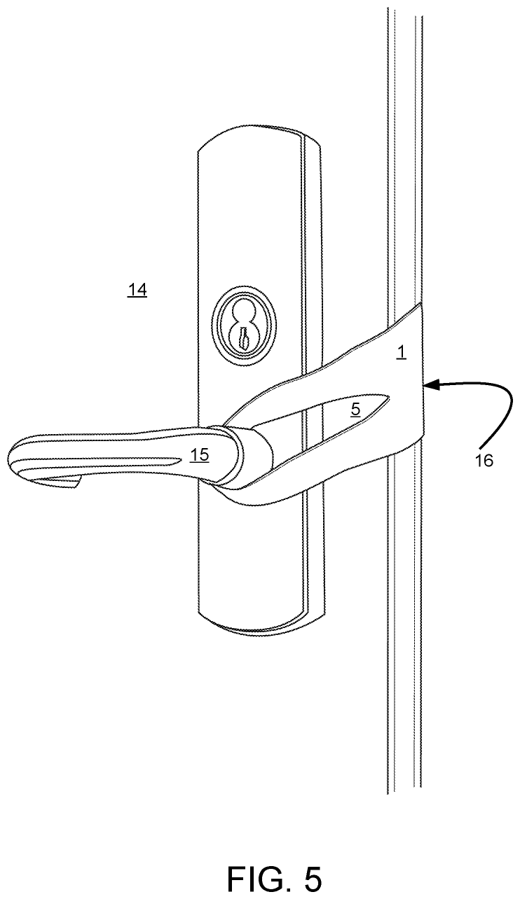

FIG. 5 is an illustration of the Emergency Duty Exit Securing Strip 1 deployed against a modern industrial-grade door 14 with a lever handle 15 and an off-center spring-bolt area 16. The handle-adaptive through-hole 5 of one end portion 3 stretches to a slot-shape fittable to the depicted lever-shaped handle. The depicted off-center spring-bolt latch location 16 is above and to the side of the lever handle 15, rather than directly to the side of the lever handle.

A device middle portion width matching the diameter of the spring-bolt latch would slip from and fail to arrest an off-center latch mechanism of the type depicted. Instead, the latch-enveloping middle portion of the invention, being at least as wide as the two handle-adaptive end portions, easily spans the vertical difference between the latch mechanism and door handles, entirely covers the latch-bolt hole, restrains the latch bolt elastically, and leaves unstretched portions of elastomer extending around the edges of the latch bolt wedgable into the strike plate.

The remaining handle-adaptive end portion of the Strip wraps around to the far side of the depicted door and is attached to the far side door mechanisms using the remaining handle-adaptive hole according to one of the methods described above. Because of the design of the latch-enveloping middle portion of the Strip, the far side door mechanisms can also be vertically off-center, upward or downward, from the latch-bolt mechanism with no degradation in latch-arresting performance by the invention.

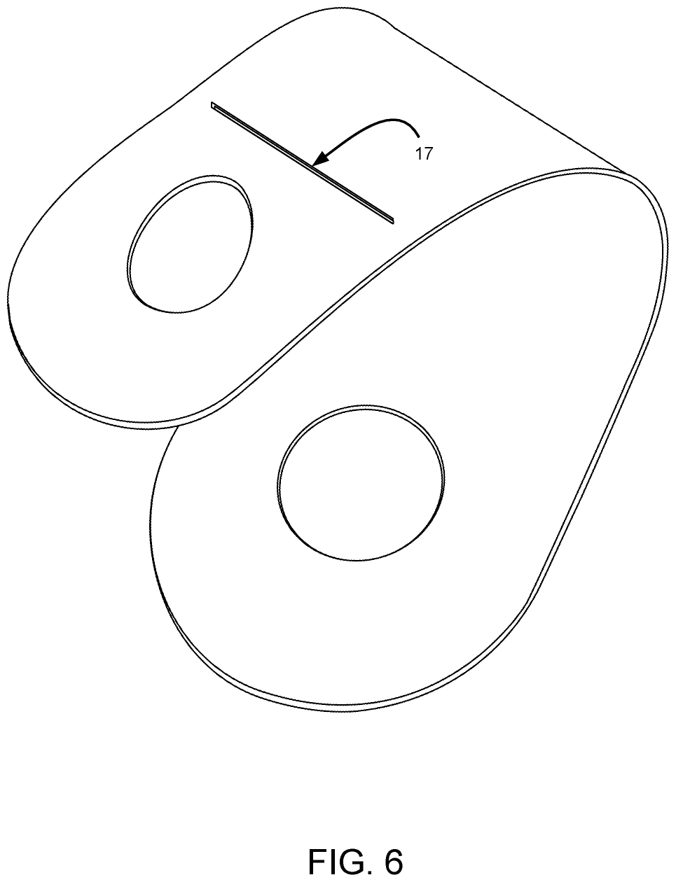

FIG. 6 shows a configuration of the emergency duty exit securing strip that includes a constriction slot 17 as part of one handle-adaptive end portion. The constriction slot is characterized by a length and a width. In this illustration, the constriction slot runs across or transverse the emergency duty exit securing strip.

In this illustration, the handle-adaptive through hole is disposed distal of the constriction slot, further from the middle portion of the Strip; thus, the constriction slot is disposed proximal of the handle-adaptive through hole, closer to the middle portion of the Strip. Although this is the preferred embodiment, the constriction slot can be disposed in other positions relative to the through hole.

The addition of the novel constriction slot in the emergency duty exit securing strip expands the range of options for applying the Strip to the various exit devices that are encountered by first responders. In some cases, it has been discovered that the handle-adaptive through-hole cannot wrap around a door handle, or is too loose when wrapped around a door handle. In such cases, an end of a Strip can be formed into a closed loop or noose around a door handle by pulling the opposite end through the handle-adaptive through-hole and through the constriction slot. The constriction slot, being narrower and thinner than the elastic Strip, holds the closed loop once tightened.

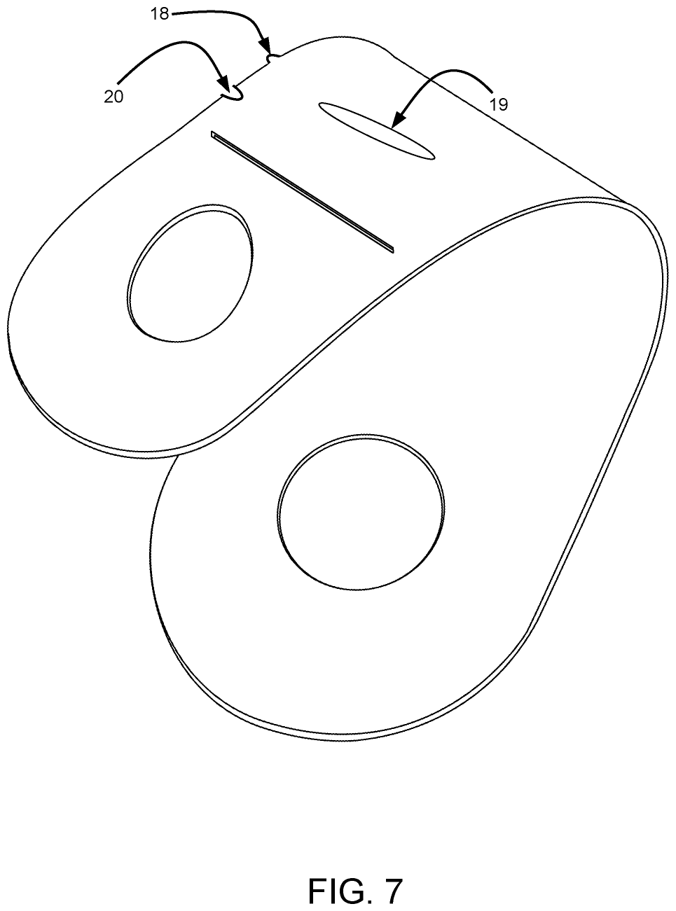

FIG. 7 illustrates a further configuration of the emergency duty exit securing strip that includes bolus points for guiding and holding a closed loop in place in conjunction with the constriction slot as disclosed above in regard to FIG. 6. The bolus points provide additional mass and additional friction as a barrier to loosening of a closed loop formed using the constriction slot. A bolus point can be an edge extrusion 18 or a surface extrusion 19 adding thickness or else an edge indentation 20, as shown. Bolus points must be proximal—nearer the middle portion of the Strip than—the constriction slot.

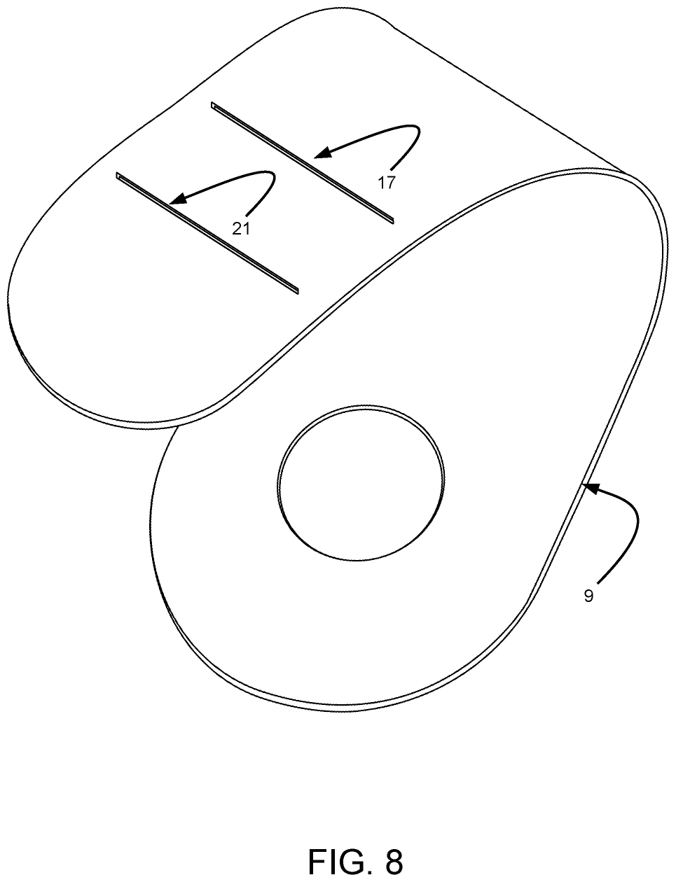

FIG. 8 illustrates a further configuration of the emergency duty exit securing strip that features two constriction slots for improved friction retention. Forming a closed loop tie by pulling the opposite end of the Strip through first one constriction slot 17 then the other 21 has the novel advantage of holding the elastic surfaces of the Strip flat against one another. This creates greater friction for holding in place the closed loop than is created by either constriction slot alone.

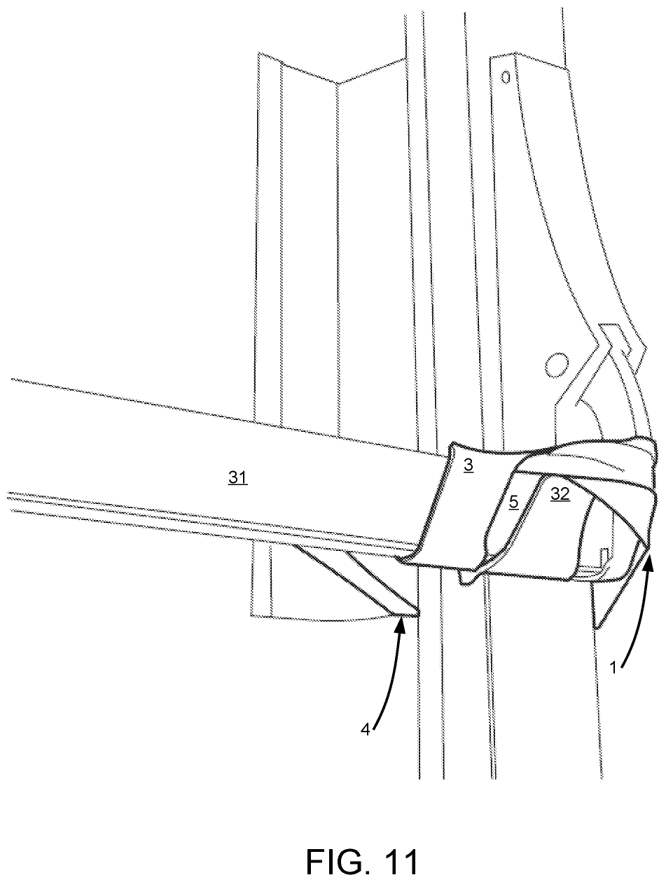

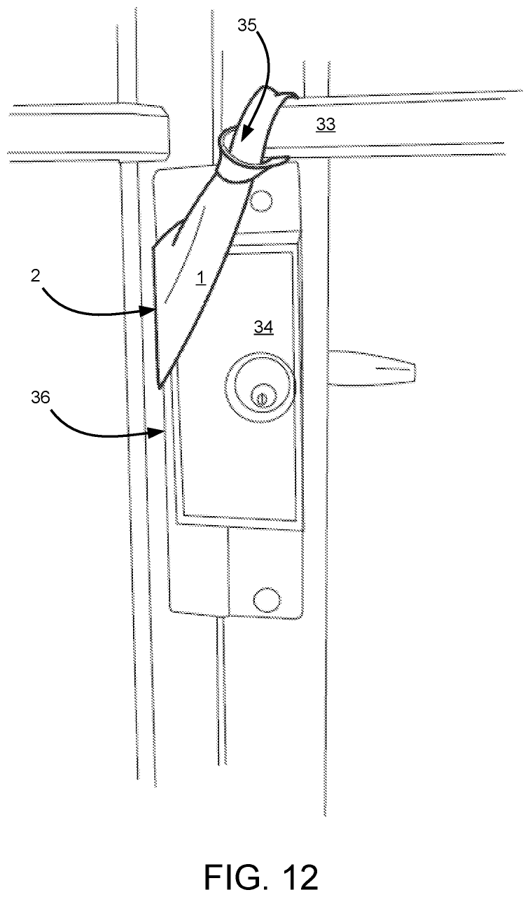

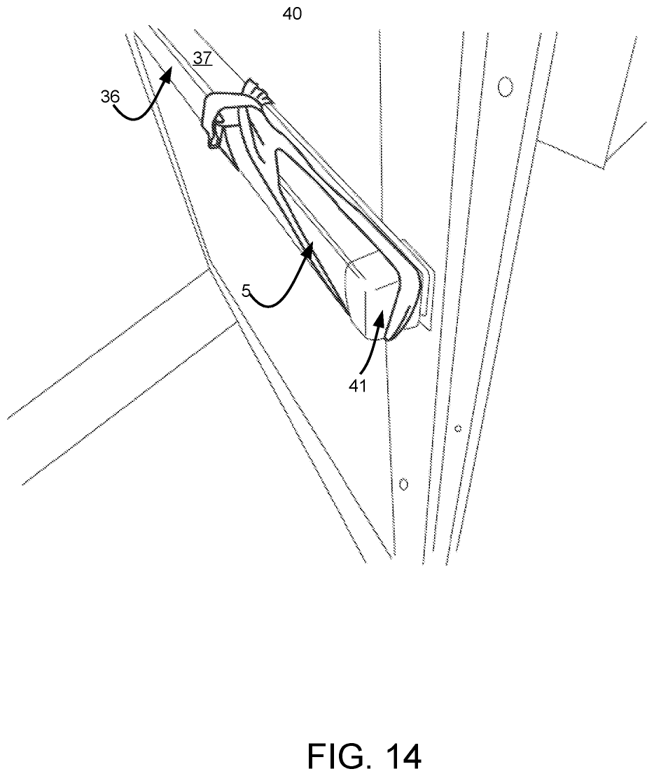

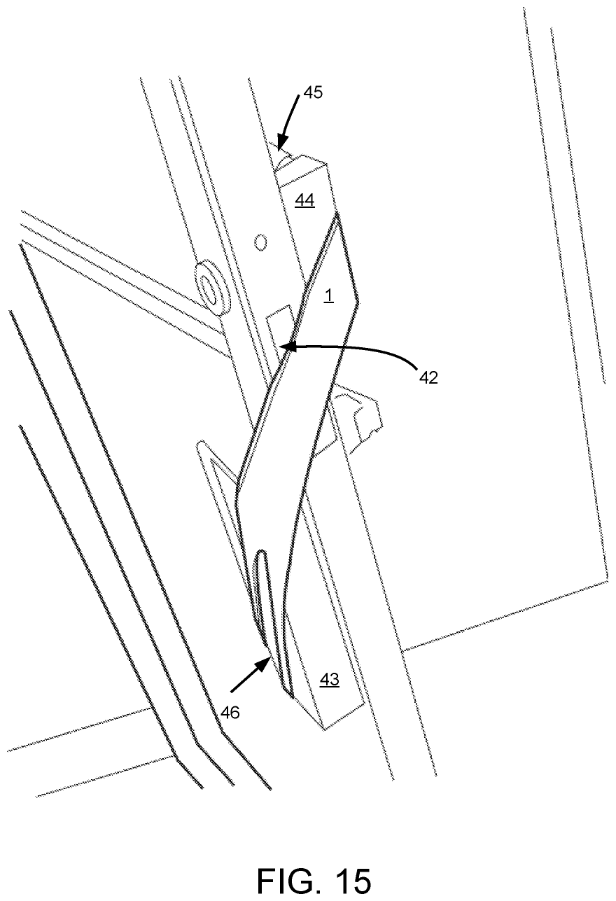

The invention is illustrated as with two constriction slots in place of a handle-adaptive through-hole, but the preferred embodiment uses the constriction slots in conjunction with a handle-adaptive through-hole in the same handle-adaptive end portion. The use of one or more constrictions slots is explained further in regard to the novel methods of FIG. 11, FIG. 12, FIG. 14 and FIG. 15, below.

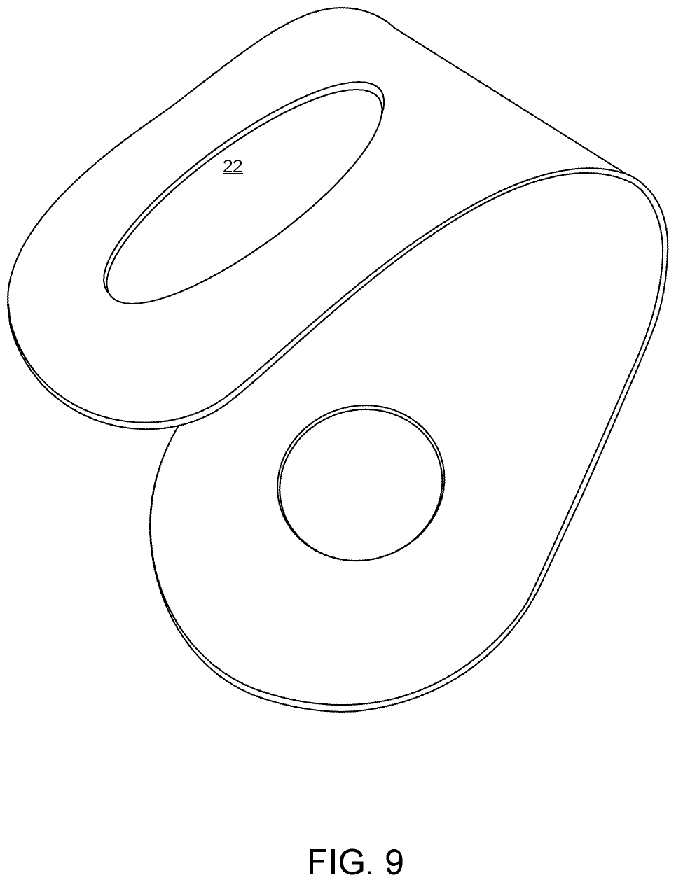

FIG. 9 illustrates a configuration of the emergency duty exit securing strip wherein a through-hole is increased in sized lengthwise, so as to wrap around a cross-bar exit device or around a pad of a touch-bar exit device. This opening, referred to here as a crash-bar adaptive through-hole 22 or panic-bar adaptive through-hole, is therefore at least 1.5 inches in length and at most 4 inches in length. To provide compensatory strength in the lengthened through-hole region of the Strip, the width of the crash-bar adaptive through-hole may be decreased to 0.5 inch.

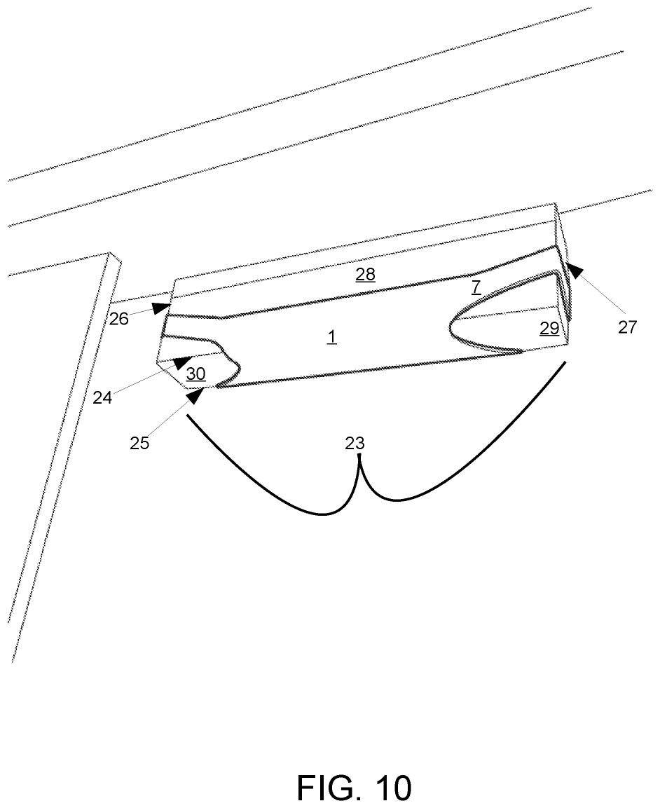

FIG. 10 illustrates a method of using the novel emergency duty exit securing strip 1 developed to disable a magnetic plate door lock. The magnetic plate door lock has two plates that can lock the door by coming together. The magnetic plate to be disabled 23 is characterized by having a length, a width and a thickness. The rectangular magnetic lock plate, accordingly, is also characterized by having a first lengthwise edge 24, a second lengthwise edge 25, a first transverse edge 26 and a second transverse edge 27.

The magnetic plate to be disabled shows a front surface 28 and has a rear surface. To disable the magnetic plate, a handle-adaptive through-hole is wrapped around a corner 29 of a rectangular magnetic lock plate such that its perimeter 7 portion covers a portion of a lengthwise edge 24 and a portion of a transverse edge 27. Next, a second handle-adaptive through-hole is wrapped around a different corner 30 of said rectangular magnetic lock plate such that the emergency-duty door-arresting strip blocks said rectangular magnetic lock plate from forming a magnetic closure.

The emergency-duty door-arresting strip can block the lengthwise edge of the magnetic lock plate, as in the illustration, with the handle-adaptive through-holes wrapped over corners that are laterally opposed. Alternatively, the handle-adaptive through-holes can be wrapped over corners that are diagonally opposed such that the rectangular magnetic lock plate front surface is blocked by the emergency-duty door-arresting strip.

FIG. 11 illustrates a method of using the novel emergency duty exit securing strip 1 developed to disable and hold unlocked an exit device known as a cross-bar 31 (or lever-bar). In this novel method of securing the exit of a cross-bar device, the cross-bar must be levered into a compressed position and held there by means of the exit securing device.

Since a door-knob hole will not reach around the long cross-bar, a noose 32 may formed by wrapping a handle-adaptive end portion 3 around the cross-bar and pulling the other end 4 of the emergency duty exit securing strip through the handle-adaptive through-hole 5. The other handle-adaptive end portion 4 of the Strip is then looped around the second door-handle of the door such that the lever-action crossbar of the door is held in a compressed position.

Additional loops may be made to pull the Strip tighter as needed to hold the cross-bar. Where the Strip has a constriction slot, the closed noose can be formed more efficiently and tighter compression of the cross-bar secured by looping the second handle-adaptive end portion through the constriction slot or, preferably, through the constriction slot and through the first handle-adaptive through-hole. With this method, a cross-bar emergency exit device can be secured unlocked without directly addressing a latch or bolt.

FIG. 12 illustrates a method of using the novel emergency duty exit securing strip 1 developed to disable a latch where one side of the door uses a loop handle 33. Either end of the loop handle is welded or affixed to the door 34 and therefore cannot be addressed by a door-knob shaped opening. Instead, a closed noose 35 is formed around the loop handle as according to FIG. 11, above.

The emergency duty latch arresting strip is stretched around the door edge 36 such that the latch-arresting middle portion 2 covers the door latch and the second handle-adaptive end portion is addressed to the opposite door handle. Where the Strip has one or more constriction slots, as in FIG. 6 or FIG. 8, above, the closed noose can formed more efficiently and tighter compression of the latch secured by looping the second handle-adaptive end portion through the constriction slots for increased friction.

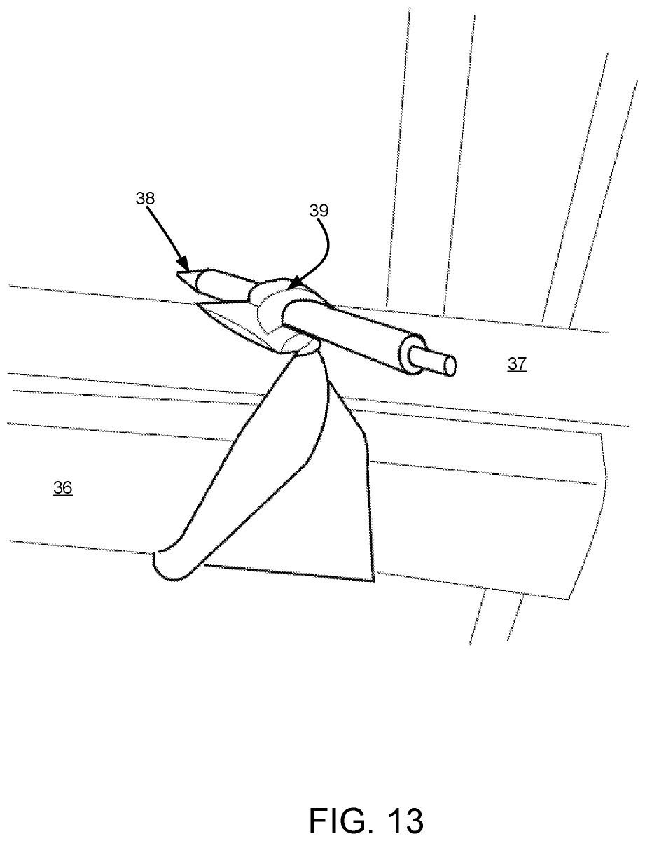

FIG. 13 illustrates a method of using the novel emergency duty exit securing strip developed to disable and hold unlocked an exit device known as a touch bar. A door with the touch bar exit device is caused to be openable by compressing the touch bar pad 36 unto the touch bar body 37. Where there is space between the door and the touch bar body, this novel method of securing the touch bar exit may be used. This novel method will work even without an addressable latch, without a handle on the opposite side of the door and when there is no option to stretch the Strip around to the opposite side of the door.

Instead, the touch bar pad is held tight to the touch bar body by compression using the emergency-duty door-arresting strip. A half-knot is tied around the touch bar pad and body using the first handle-adaptive end portion and second handle-adaptive end portions of the Strip as knot-ends. A windlass rod 38 is placed above the half-knot, and then a full knot is completed over the windlass rod.

This forms a compression knot. The compression knot may then be tightened by twisting the windlass rod, forming a tightened elastomer strip compression knot 39 as necessary to compress the touch bar pad into an open exit state for the door. The windlass rod ends may be wedged under the now-tightened Strip to hold the bar in place. The windlass rod may be formed of a pen, small flashlight, or similar long, thin item often available to emergency responders. The windlass rod may also be formed of a nail or similar long, thin item often present as discarded building construction material.

In a variation of the compression method of FIG. 13, above, FIG. 14 shows how an elastomer strip compression knot 40 may be formed over the middle portion of a touch bar exit device using the Strip. In this method variation, a windlass rod is not available. Instead, the elastomer strip compression knot is held in place by wrapping a handle-adaptive through-hole 5 around an end 41 of the touch bar 36. Friction holds the elastomer strip compression knot around the middle portion of the touch bar, and stretching the Strip around an end of the touch bar provides tension to hold the elastomer strip compression knot tight.

FIG. 15 illustrates a method of using the novel emergency duty exit securing strip 1 developed to disable a latch 42 where the door uses a rectangular push handle 43 on one side and a rectangular pull handle 44 on the other side, vertically offset from one another.

In this method, a handle-adaptive through-hole 5 is wrapped around the high corner 45 of the higher offset rectangular handle, and the second handle-adaptive through-hole is wrapped around the low corner 46 of the lower offset rectangular handle. The emergency duty latch arresting strip is thereby stretched diagonally across the door latch.

In instances where the Strip has a crashbar-adaptive through-hole, as described in FIG. 9 above, this can be looped entirely around a rectangular handle. In a variant method, a closed noose can be formed around a rectangular handle using a Strip equipped with a constriction slot.

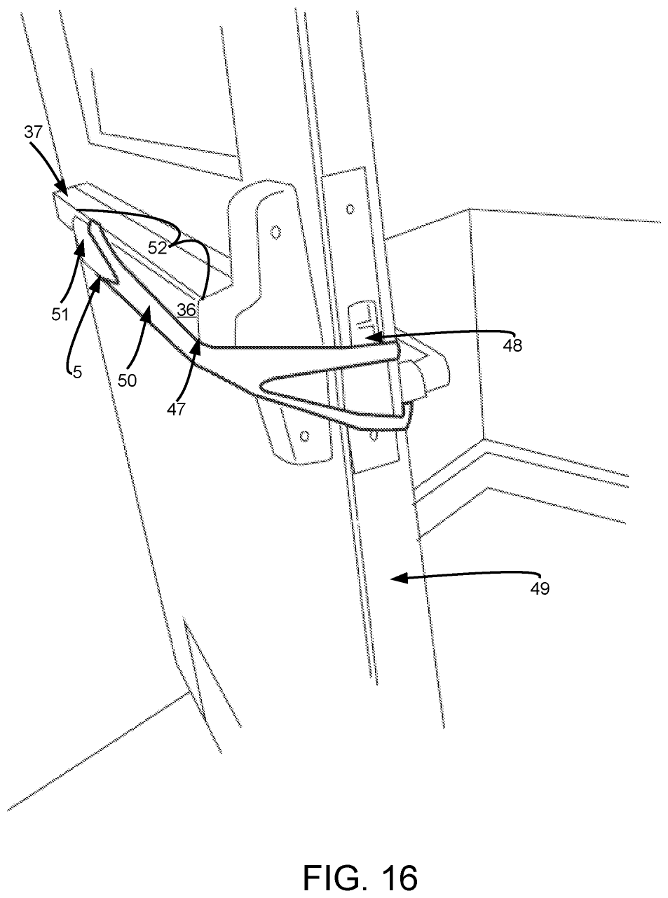

FIG. 16 illustrates a method of using the novel emergency duty exit securing strip developed to disable and hold unlocked a touch bar exit device. This method is usable where there is no space between the door and the touch bar body 37 such that the method of FIG. 13 cannot be used. The touch bar comprises a pad 36 and a body, said touch bar pad comprising a near end 47 adjacent the latch 48 of the door 49, a middle portion 50 and a far end opposite 51 the touch bar pad near end, the touch bar pad describing a length.

The method is workable by by applying the handle-adaptive through-hole 5 of the first handle-adaptive end portion of the emergency-duty latch-disabling strip of the invention around the far end of the touch bar pad. The other end of the Strip is secured to any handle on the opposite side of the door. Then, by stretching the emergency-duty door-arresting strip along the length 52 of the touch bar pad such that the touch bar pad is compressed against the touch bar body, the exit device is secured in an open state.

Because the invention is often deployed in rugged outdoor environments, direct sunlight, industrial facilities, warehouses and chemical storage, or during structure fire emergencies, the surface temperature of doors and door hardware can reach high temperatures. Therefore, Emergency Duty Exit Securing Strip uses elastomer materials rated to withstand heat up to two-hundred and twelve degrees Fahrenheit (212 F). It must also be able to withstand cold as low as negative 20 degrees Fahrenheit (−20 F) without becoming brittle or breaking in use.

In an alternate embodiment, the Emergency Duty Exit Securing Strip is made in a one-use format. The Strip is disposed with a one-use adhesive portion protected by a sticker backing or plastic baggy. The adhesive portion adheres the Strip to itself or to the door, making removal difficult without tearing. This one-use format can be used in areas where passers-by have a tendency to remove or reuse the Strips, or to aid in preserving the chain of events for later evidentiary reporting. For evidentiary purpose, an alternate embodiment may also be pre-markable with identifying information.

Although the present invention has been described in connection with certain specific embodiments for instructional purposes, the present invention is not limited thereto. Accordingly, various modifications, adaptations, and combinations of various features of the described embodiments can be practiced without departing from the scope of the invention.

What is claimed is:

1. An emergency duty exit securing strip configured to be applied to a door having an exit device, comprising:
a flat elastomer strip having a rest length, a stretch length, a rest width and a thickness,
said rest length being greater than said rest width and said rest width being greater than said thickness,
said stretch length being the greatest length to which the flat elastomer strip can be stretched lengthwise before breaking,
said flat elastomer strip having a lengthwise elasticity, said lengthwise elasticity being defined as the ratio of the flat elastomer strip's stretch length to its rest length,
said flat elastomer strip comprising:
a first handle-adaptive end portion being an end of the flat elastomer strip,
a second handle-adaptive end portion being an end of the flat elastomer strip opposite the first handle-adaptive end portion,
a latch-enveloping middle portion disposed between the first handle-adaptive end portion and second handle-adaptive end portion,
said first handle-adaptive end portion having a first handle-adaptive through-hole with a perimeter;
said second handle-adaptive end portion having a second handle-adaptive through-hole with a perimeter;
said first handle-adaptive end portion also having a first constriction slot opening adjacent the first handle-adaptive through-hole
the flat elastomer strip having a combination of rest length and lengthwise elasticity sufficient for the flat elastomer strip to span from one portion of said exit device to any other portion of said exit device.

2. The emergency duty exit securing strip of claim 1,
wherein the first constriction slot opening has a width and a length and wherein the first constriction slot opening runs transverse the first handle-adaptive end portion.

3. The emergency duty exit securing strip of claim 1,
wherein the first handle-adaptive end portion has a distal end and a proximal end, said proximal end being adjacent the latch-arresting middle portion; and,
wherein the first handle-adaptive end portion further comprises at least one friction extrusion, said friction extrusion being proximal of said first constriction slot.

4. The emergency duty exit securing strip of claim 1,
said first handle-adaptive end portion having, rather than a first handle-adaptive through-hole,
a first constriction slot opening.

5. The emergency duty exit securing strip of claim 1,
said first handle-adaptive end portion having, rather than a first handle-adaptive through-hole,
a first constriction slot opening and a second constriction slot opening adjacent the first constriction slot opening.

6. The emergency duty exit securing strip of claim 1,
said first handle-adaptive through-hole being a push-bar adaptive through-hole having a push-bar adaptive through-hole length and a push-bar adaptive through-hole width,
said push-bar adaptive through-hole length being greater than said push-bar adaptive through-hole width,
said push-bar adaptive through-hole length being situated lengthwise the first handle-adaptive end portion.

7. A method of securing a door in an open state using an emergency duty exit securing strip,
said emergency duty exit securing strip comprising:
a flat elastomer strip having a rest length, a stretch length, a rest width and a thickness,
said rest length being greater than said rest width and said rest width being greater than said thickness,
said stretch length being the greatest length to which the flat elastomer strip can be stretched lengthwise before breaking,
said flat elastomer strip having a lengthwise elasticity, said lengthwise elasticity being defined as the ratio of the flat elastomer strip's stretch length to its rest length,
said flat elastomer strip comprising:
a first handle-adaptive end portion being an end of the flat elastomer strip,
a second handle-adaptive end portion being an end of the flat elastomer strip opposite the first handle-adaptive end portion, and
a latch-enveloping middle portion disposed between the first handle-adaptive end portion and second handle-adaptive end portion,
said first handle-adaptive end portion having a first handle-adaptive through-hole with a perimeter portion;
said second handle-adaptive end portion having a second handle-adaptive through-hole with a perimeter portion;
said method comprising the steps of:
wrapping said first handle-adaptive through-hole around a corner of a rectangular magnetic lock plate
the rectangular magnetic lock plate having a length, a width and a thickness,
the rectangular magnetic lock plate accordingly having a front surface and a rear surface,
the rectangular magnetic lock plate also accordingly having a first lengthwise edge and a second lengthwise edge opposite the rectangular magnetic lock plate first lengthwise edge,
the rectangular magnetic lock plate also accordingly having a first transverse edge and a second transverse edge opposite the rectangular magnetic lock plate first transverse edge;
said first handle-adaptive through-hole being wrapped such that its perimeter portion covers a portion of said rectangular magnetic lock plate first lengthwise edge and covers a portion of said rectangular magnetic lock plate first transverse edge; and,
wrapping said second handle-adaptive through-hole around a different corner of said rectangular magnetic lock plate
such that the emergency duty exit securing strip blocks said rectangular magnetic lock plate from forming a magnetic closure.

8. The method of claim 7, wherein said emergency duty exit securing strip is stretched along the rectangular magnetic lock plate first lengthwise edge.

9. The method of claim 7, wherein said emergency duty exit securing strip is stretched across the rectangular magnetic lock plate front surface.

10. A method of securing a door in an open state using an emergency duty exit securing strip,
said emergency duty exit securing strip comprising
a flat elastomer strip having a rest length, a stretch length, a rest width and a thickness,
said rest length being greater than said rest width and said rest width being greater than said thickness,
said stretch length being the greatest length to which the flat elastomer strip can be stretched lengthwise before breaking,
said flat elastomer strip having a lengthwise elasticity, said lengthwise elasticity being defined as the ratio of the flat elastomer strip's stretch length to its rest length,
said flat elastomer strip comprising:
a first handle-adaptive end portion being an end of the flat elastomer strip,
a second handle-adaptive end portion being an end of the flat elastomer strip opposite the first handle-adaptive end portion,
a latch-enveloping middle portion disposed between the first handle-adaptive end portion and second handle-adaptive end portion,
said first handle-adaptive end portion having a first handle-adaptive through-hole with a perimeter portion;
said second handle-adaptive end portion having a second handle-adaptive through-hole with a perimeter portion;
said door comprising an exit device and a latch;
said method comprising the steps of:
wrapping said first handle-adaptive end portion around a first portion of the exit device, said first exit device portion being a lever-action crossbar;
pulling said second handle-adaptive end portion through the first handle-adaptive through-hole to form a closed noose;
wrapping the second handle-adaptive end portion around a second portion of the exit device such that the lever-action crossbar of the exit device is held in a compressed position.

11. The method of claim 10, comprising the steps of:
wrapping said emergency duty exit securing strip around the exit device of the door,
said exit device being a touch bar comprising a pad and a body, said touch bar pad comprising a near end adjacent a latch of the door, a middle portion and a far end opposite the touch bar pad near end;
tying a half-knot using said first handle-adaptive end portion and said second handle-adaptive end portion;
placing a windlass bar over the half-knot, said windlass bar being a pen, nail or small flashlight;
tying a full knot over the windlass bar; and,
twisting the windlass bar until the touch bar pad is compressed against the touch bar body such that said door is held in an unlatched state.

12. The method of claim 11, further comprising the step of:
securing the windlass bar by passing it partially through a constriction slot or handle-adaptive through-hole.

13. The method of claim 10, comprising the steps of:
wrapping said emergency duty exit securing strip one or more times around the exit device of the door,
said exit device being a touch bar comprising a pad and a body, said touch bar pad comprising a near end adjacent a latch of the door, a middle portion and a far end opposite the touch bar pad near end;
pulling said second handle-adaptive end portion through the first handle-adaptive through-hole to form a closed noose;
pulling the closed noose tight until the touch bar pad is compressed against the touch bar body;
wrapping the handle-adaptive through-hole of the second handle-adaptive end portion around either the near end of the touch bar pad or else the far end of the touch bar pad, such that said door is held in an unlatched state.

14. The method of claim 10,
wherein the exit device of the door is a touch bar comprising a pad and a body, said touch bar pad comprising a near end adjacent the latch of the door, a middle portion and a far end opposite the touch bar pad near end, the touch bar pad having a length;
the method comprising the steps of:
wrapping the handle-adaptive through-hole of the first handle-adaptive end portion around the far end of the touch bar pad;
wrapping the handle-adaptive through-hole of the second handle-adaptive end portion around the second door handle; and,
stretching the emergency duty exit securing strip along the length of the touch bar pad such that the touch bar pad is compressed against the touch bar body.

15. The method of claim 10,
wherein the exit device of the door is a touch bar comprising a pad and a body, said touch bar pad comprising a near end adjacent the latch of the door, a middle portion and a far end opposite the touch bar pad near end, the touch bar pad having a length;
the method comprising the steps of:
wrapping the handle-adaptive through-hole of the first handle-adaptive end portion around the touch bar pad, the handle-adaptive through-hole of the first handle-adaptive end portion being a crash-bar adaptive through-hole;
wrapping the handle-adaptive through-hole of the second handle-adaptive end portion around a second portion of the exit device such that the latch-arresting middle portion of the emergency duty exit securing strip covers said latch.

16. The method of claim 10,
wherein a door-handle portion of the exit device of the door is a rectangular push-pad or pull-pad offset vertically lower than the latch, said first door-handle having a lower outside corner;
wherein a second door-handle portion of the exit device of the door is a rectangular push-pad or pull-pad offset vertically higher than the latch, said second door-handle portion having a higher outside corner;
the method comprising the steps of:
wrapping the handle-adaptive through-hole of the first handle-adaptive end portion around said lower outside corner of the first door-handle portion;
wrapping the handle-adaptive through-hole of the second handle-adaptive end portion around said higher outside corner of the second door-handle portion; and,
stretching the emergency duty exit securing strip diagonally such that the latch-arresting middle portion covers the door latch.

17. The method of claim 16,
the method comprising the step of:
wrapping the handle-adaptive through-hole of the first handle-adaptive end portion around the entirety of the first door-handle portion,
the handle-adaptive through-hole of the first handle-adaptive end portion being a crash-bar adaptive through-hole.

18. The method of claim 16,
the first handle-adaptive end portion comprising a constriction slot; and,
the method comprising the step of:
forming a closed noose around the entirety of the first door-handle using the constriction slot.

19. The method of claim 10,
wherein the first door-handle portion of the exit device is a loop handle comprising a near end adjacent a latch of the door, a middle portion and a far end opposite the loop handle near end, the near end and the far end being affixed to the door;
the method comprising the steps of:
wrapping said first handle-adaptive end portion around the loop handle of the door;
pulling said second handle-adaptive end portion through the first handle-adaptive through-hole to form a closed noose;
wrapping the second handle-adaptive end portion around a second door-handle portion of the exit device; and,
stretching the emergency duty exit securing strip such that the latch-arresting middle portion covers the door latch.

20. The method of claim 19,
the first handle-adaptive end portion comprising a constriction slot; and,
the method further comprising:
forming the closed noose using the constriction slot.
